(19) United States
(12) Patent Application Publication
(10) Pub. No.: US 2011/0298729 A1
(43) Pub. Date: Dec. 8, 2011

(54) TOUCH PANEL AND METHOD OF MANUFACTURING THE SAME

(75) Inventors: Jae Il Kim, Gyunggi-do (KR); Yong Soo Oh, Gyunggi-do (KR); Woon Chun Kim, Gyunggi-do (KR); Jong Young Lee, Gyunggi-do (KR)

(73) Assignee: SAMSUNG ELECTRO-MECHANICS CO., LTD., Gyunggi-do (KR)

(21) Appl. No.: 12/883,912

(22) Filed: Sep. 16, 2010

(30) Foreign Application Priority Data
Jun. 8, 2010 (KR) 1020100054035

(51) Int. Cl. G06F 3/041; B05D 5/12

(52) U.S. Cl. 345/173; 427/108

(57) ABSTRACT

Disclosed herein is a touch panel including: a transparent substrate 10, transparent electrodes 20 patterned and formed on the transparent substrate 10, and a non-conductive and colored transmittance compensation material 40 filled in an opening part 30 formed between the patterned transparent electrodes 20. In the touch panel, the opening part 30 formed between the transparent electrodes patterned and formed on the transparent substrate 10 is filled with the transmittance compensation material 40 to compensate for a difference in light transmittance and reduce abrupt change in the refractive index, thereby making it possible to improve visibility of the entire touch panel. In addition, the opening part between the patterned transparent electrodes 20 is filled with the non-conductive transmittance compensation material 40 to prevent an electrical short between the patterned transparent electrodes 20, thereby making it possible to improve reliability of the operation of the touch panel.

### CROSS REFERENCE TO RELATED APPLICATION

This application claims the benefit of Korean Patent Application No. 10-2010-0054035, filed on Jun. 8, 2010, entitled “Touch Panel And Method Of Manufacturing The Same”, which is hereby incorporated by reference in its entirety into this application.

### BACKGROUND OF THE INVENTION

1. Technical Field

The present invention relates to a touch panel and a method of manufacturing the same.

2. Description of the Related Art

Alongside the growth of computers using digital technology, devices assisting the computers have also been developed, and personal computers, portable transmitters and other personal information processors execute processing of text and graphics using a variety of input devices such as a keyboard, a mouse and so on.

While the rapid advancement of the information-based society has been widening the use of computers more and more, there have been occurring the problems of it being difficult to efficiently operate products using only the keyboard and mouse as being currently responsible for the input device function. Thus, the demand for a device that is simple, does not malfunction, and has the capability to easily input information is increasing.

Furthermore, current techniques for input devices exceed the level of fulfilling general functions and thus are progressing towards techniques related to high reliability, durability, innovation, designing and manufacturing. To this end, a touch panel has been developed as an input device capable of inputting information such as text and graphics.

The touch panel is mounted on the display surface of an image display device such as an electronic organizer, a flat panel display including a liquid crystal display (LCD), a plasma display panel (PDP), an electroluminescence (El) element or the like, or a cathode ray tube (CRT), so that a user selects the information desired while viewing the image display device.

The touch panel is classifiable as a resistive type, a capacitive type, an electromagnetic type, a surface acoustic wave (SAW) type, and an infrared type. The type of touch panel selected is one that is adapted for an electronic product in consideration of not only signal amplification problems, resolution differences and the degree of difficulty of designing and manufacturing technology but also in light of optical properties, electrical properties, mechanical properties, resistance to the environment, input properties, durability and economic benefits of the touch panel. In particular, resistive and capacitive types are prevalently used in a broad range of fields currently.

FIG. 1 is a diagram showing a substrate on which a transparent electrode pattern according to the prior art is formed, and FIG. 2 is a cross-sectional view taken along line A-A′ of FIG. 1. As shown in FIGS. 1 and 2, in a capacitive touch panel or a digital resistive touch panel, an opening part 130 is formed between patterned transparent electrodes 120, such that visibility of the touch panel is degraded and distortion is generated due to the difference in light transmittance and the abrupt change in the refractive index. In addition, an electrical short may be generated between the finely patterned transparent electrodes 120, such that reliability of the operation of the touch panel is degraded.

### SUMMARY OF THE INVENTION

The present invention has been made in an effort to provide a touch panel that can improve visibility of the touch panel and prevent an electrical short between patterned transparent electrodes by filling an opening part between the patterned transparent electrodes with a transmittance compensation material, and a method of manufacturing the same.

A touch panel according to a preferred embodiment of the present invention includes: a transparent substrate; transparent electrodes patterned and formed on the transparent substrate; and a non-conductive and colored transmittance compensation material filled in an opening part formed between the patterned transparent electrodes.

Herein, the transmittance compensation material is formed by mixing polyethyleneterephthalate (PET) with a non-conductive colored material.

Further, the transmittance compensation material is formed by mixing polymethylmethacrylate (PMMA) with a non-conductive colored material.

Further, the transparent electrode is made of a conductive polymer.

Further, the conductive polymer includes poly-3, 4-ethylenedioxythiophene/polystyrenesulfonate (PEDOT/PSS), polyaniline, polyacetylene, or polyphenylenevinylene.

A method of manufacturing a touch panel according to a preferred embodiment of the present invention includes: (A) preparing a transparent substrate, (B) patterning and forming transparent electrodes on the transparent substrate, and (C) filling an opening part formed between the transparent electrode patterns with a non-conductive and colored transmittance compensation material.

Herein, the transmittance compensation material is filled using a roll-to-roll apparatus or a doctor blade.

Herein, the transmittance compensation material is formed by mixing polyethyleneterephthalate (PET) with a non-conductive colored material.

Further, the transmittance compensation material is formed by mixing polymethylmethacrylate (PMMA) with a non-conductive colored material.

Further, the transparent electrode is made of a conductive polymer.

Further, the conductive polymer includes poly-3, 4-ethylenedioxythiophene/polystyrenesulfonate (PEDOT/PSS), polyaniline, polyacetylene, or polyphenylenevinylene.

### BRIEF DESCRIPTION OF THE DRAWINGS

FIG. 1 is a perspective view of a substrate on which a transparent electrode pattern according to the prior art is formed;

FIG. 2 is a cross-sectional view taken along line A-A′ of FIG. 1;

FIG. 3 is a cross-sectional view of a touch panel according to a preferred embodiment of the present invention; and

FIGS. 4 and 6 are diagrams showing a method of manufacturing a touch panel according to a preferred embodiment of the present invention.

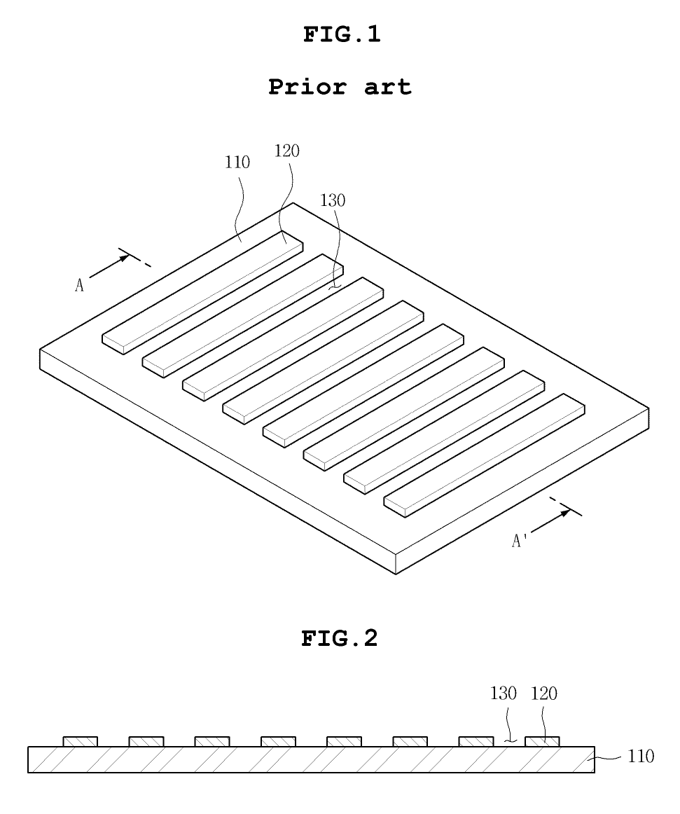

### DESCRIPTION OF THE PREFERRED EMBODIMENTS

Various objects, advantages and features of the invention will become apparent from the following description of embodiments with reference to the accompanying drawings.

The terms and words used in the present specification and claims should not be interpreted as being limited to typical meanings or dictionary definitions, but should be interpreted as having meanings and concepts relevant to the technical scope of the present invention based on the rule according to which an inventor can appropriately define the concept of the term to describe most appropriately the best method he or she knows for carrying out the invention.

The above and other objects, features and advantages of the present invention will be more clearly understood from the following detailed description taken in conjunction with the accompanying drawings. In the specification, in adding reference numerals to components throughout the drawings, it is to be noted that like reference numerals designate like components even though components are shown in different drawings. Further, in describing the present invention, a detailed description of related known functions or configurations will be omitted so as not to obscure the subject of the present invention.

Hereinafter, preferred embodiments of the present invention will be described in detail with reference to the accompanying drawings.

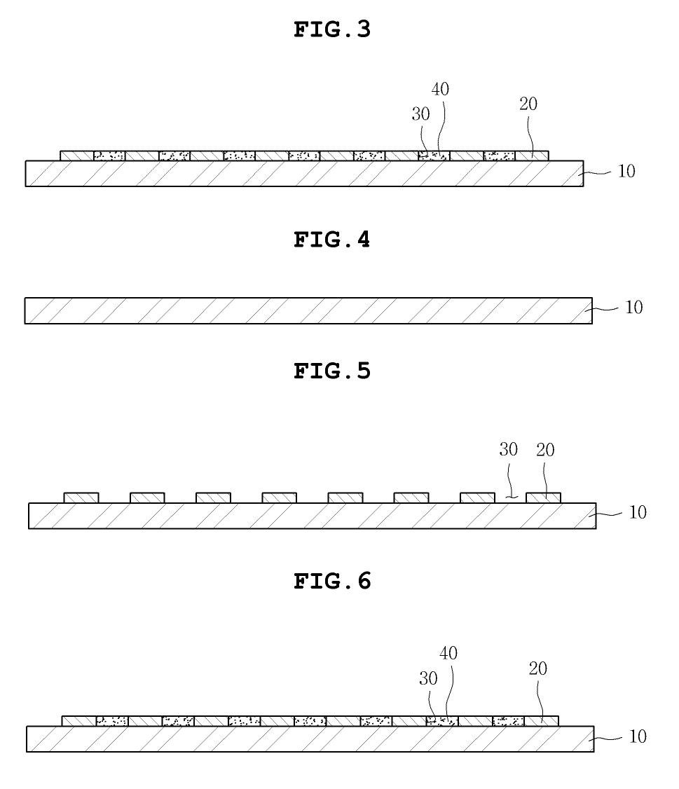

FIG. 3 is a cross-sectional view of a touch panel according to a preferred embodiment of the present invention.

As shown in FIG. 3, a touch panel according to a preferred embodiment of the present invention includes a transparent substrate 10, transparent electrodes 20 patterned and formed on the transparent substrate 10, and a non-conductive and colored transmittance compensation material 40 filled in an opening part 30 formed between the patterned transparent electrodes 20.

The transparent substrate 10 includes an active region (not shown) and a bezel region (not shown), wherein the active region is a portion on which the transparent electrodes 20 are installed in order to recognize a user's touch and is positioned in the center of the transparent substrate 10. The bezel region is a portion on which wiring electrodes connected to the transparent electrodes 20 are formed is provided at the edges of the active region. Herein, the material of the transparent substrate 10 is not particularly limited, and may include polyethyleneterephthalate (PET), polycarbonate (PC), polymethylmethacrylate (PMMA), polyethylenenaphthalate (PEN), polyethersulfone (PES), cyclic olefin copolymer (COC), a triacetylcellulose (TAC) film, a polyvinyl alcohol (PVA) film, a polyimide (PI) film, polystyrene (PS), biaxially oriented polystyrene (BOPS; containing K resin), glass or tempered glass and so on. In addition, the transparent electrode 20 formed on one surface of the transparent substrate 10 should be coated, it is preferable to perform a high frequency treatment or a primer treatment thereon in order to improve adhesion.

The transparent electrode 20, which generates signals when a user touches the panel, to allow a controller (not shown) to recognize the touched coordinates, is formed in the active region of the transparent substrate 10. Herein, the transparent electrode 20 may include a conductive polymer having excellent flexibility and a simple coating process as well as indium tin oxide (ITO) that is commonly used. At this time, the conductive polymer includes poly-3, 4-ethylenedioxythiophene/polystyrenesulfonate (PEDOT/PSS), polyaniline, polyacetylene, polyphenylenevinylene, or the like. As shown in FIG. 3, even though the transparent electrode 20 may be formed to have a bar shape, it is not limited thereto but may be formed to have all patterns publicly known in the art, such as a triangular shape, a hexagonal shape, or the like. The transparent electrodes 20 are patterned by laser etching or etching and the opening part 30 is formed between the patterned transparent electrodes 20. Herein, the opening part 30 formed between the patterned transparent electrodes 20 distorts light transmittance and abruptly changes the refractive index on the entire touch panel, thereby degrading visibility of the touch panel due to. Therefore, in the touch panel according to the present embodiment, the opening part 30 is filled with the transmittance compensation material 40, thereby making it possible to solve the problem that the visibility of the entire touch panel is degraded.

The non-conductive and colored transmittance compensation material 40 is a material filled in the opening part 30 between the patterned transparent electrodes 20. The non-conductive and colored material is used, thereby making it possible to prevent electrical short between the patterned transparent electrodes 20 and the transmittance of the touch panel is compensated, thereby making it possible to improve visibility of the entire touch panel. Herein, the transmittance compensation material 40 may be formed by mixing polyethyleneterephthalate (PET) with a non-conductive colored material or be formed by mixing polymethylmethacrylate (PMMA) with a non-conductive colored material. At this time, the colored material may use ink and may also use various non-conductive and colorable materials.

FIGS. 4 and 6 are diagrams showing a method of manufacturing a touch panel according to a preferred embodiment of the present invention.

A method of manufacturing a touch panel according to a preferred embodiment of the present invention includes (A) preparing a transparent substrate, (B) patterning and forming transparent electrodes on the transparent substrate, and (C) filling an opening part formed between the transparent electrode patterns with a non-conductive and colored transmittance compensation material.

In FIG. 4, a transparent substrate 10 is prepared. Herein, the material of the transparent substrate 10 is not particularly limited, and may include polyethyleneterephthalate (PET), polycarbonate (PC), polymethylmethacrylate (PMMA), glass or tempered glass and so on. In addition, since the transparent electrode 20 should be coated on one surface of the transparent substrate 10, it is preferable to perform a high frequency treatment or a primer treatment thereon in order to improve adhesion.

In FIG. 5, patterned transparent electrodes 20 are formed on the transparent substrate 10. Even though the patterned transparent electrode 20 may be formed to have a bar shape (see FIG. 3), it is not limited thereto but may be formed to have all patterns publicly known in the art, such as a triangular shape, a hexagonal shape, or the like. Herein, the transparent electrode 20 may include a conductive polymer as well as indium tin oxide (ITO) that is commonly used. At this time, the conductive polymer includes poly-3, 4-ethylenedioxythiophene/polystyrenesulfonate (PEDOT/PSS), polyaniline, polyacetylene, polyphenylenevinylene, or the like. When the transparent electrodes 20 are patterned, an opening part 30 is formed between the patterned transparent electrodes 20. At this time, the opening part 30 causes a difference in light transmittances and abrupt change in the refractive index on the entire touch panel, thereby distorting visibility of the touch panel. In order to solve the problems, the opening part is filled with a transmittance compensation material 40 to be described below.

In FIG. 6, the opening part 30 formed between the patterned transparent electrodes 20 is filed with the transmittance compensation material 40. A method of filling the opening part 30 with the transmittance compensation material 40 may be performed by various methods. The opening part 30 between the patterned transparent electrodes 20 may be uniformly filled with the transmittance compensation material 40 using an automated roll-to-roll method or a doctor blade. Besides the methods, a method of filling the opening part 30 with the transmittance compensation material 40 may be performed using other methods, if they are suitable for the object of the present invention. Herein, the transmittance compensation material 40 may be formed by mixing polyethyleneterephthalate (PET) with a non-conductive colored material or be formed by mixing polymethylmethacrylate (PMMA) with a non-conductive colored material. The colored material may use ink and may also use various non-conductive and colorable materials. The opening part 30 formed between the patterned transparent electrodes 20 is filled with the transmittance compensation material 40, thereby making it possible to improve visibility of the entire touch panel and prevent an electrical short between the transparent electrodes 20.

According to the present invention, the opening part between the transparent electrodes patterned and formed on the transparent substrate is filled with the transmittance compensation material to compensate for the entire transmittance of the touch screen panel, thereby making it possible to improve visibility.

In addition, the opening part is filled with the transmittance compensation material to reduce the abrupt change in the refractive index generated when light is transmitted, thereby making it possible to improve visibility of the touch panel.

In addition, the opening part between the patterned transparent electrodes is filled with the non-conductive transmittance compensation material to prevent an electrical short between the patterned transparent electrodes, thereby making it possible to improve reliability of the operation of the touch panel.

Although the preferred embodiments of the present invention have been disclosed for illustrative purposes, they are for specifically explaining the present invention and thus a touch panel and a method of manufacturing the same according to the present invention are not limited thereto, but those skilled in the art will appreciate that various modifications, additions and substitutions are possible, without departing from the scope and spirit of the invention as disclosed in the accompanying claims. Accordingly, such modifications, additions and substitutions should also be understood to fall within the scope of the present invention.

What is claimed is:

1. A touch panel, comprising:
a transparent substrate;
transparent electrodes patterned and formed on the transparent substrate; and
a non-conductive and colored transmittance compensation material filled in an opening part formed between the patterned transparent electrodes.

2. The touch panel as set forth in claim 1, wherein the transmittance compensation material is formed by mixing polyethyleneterephthalate (PET) with a non-conductive colored material.

3. The touch panel as set forth in claim 1, wherein the transmittance compensation material is formed by mixing polymethylmethacrylate (PMMA) with a non-conductive colored material.

4. The touch panel as set forth in claim 1, wherein the transparent electrode is made of a conductive polymer.

5. The touch panel as set forth in claim 4, wherein the conductive polymer includes poly-3,4-ethylenedioxythiophene/polystyrenesulfonate (PEDOT/PSS), polyaniline, polyacetylene or polyphenylenevinylene.

6. A method of manufacturing a touch panel, comprising:
(A) preparing a transparent substrate;
(B) patterning and forming transparent electrodes on the transparent substrate; and
(C) filling an opening part formed between the transparent electrode patterns with a non-conductive and colored transmittance compensation material.

7. The method of manufacturing a touch panel as set forth in claim 6, wherein the transmittance compensation material is filled using a roll-to-roll apparatus or a doctor blade.

8. The method of manufacturing a touch panel as set forth in claim 6, wherein the transmittance compensation material is formed by mixing polyethyleneterephthalate (PET) with a non-conductive colored material.

9. The method of manufacturing a touch panel as set forth in claim 6, wherein the transmittance compensation material is formed by mixing polymethylmethacrylate (PMMA) with a non-conductive colored material.

10. The method of manufacturing a touch panel as set forth in claim 6, wherein the transparent electrode is made of a conductive polymer.

11. The method of manufacturing a touch panel as set forth in claim 10, the conductive polymer includes poly-3,4-ethylenedioxythiophene/polystyrenesulfonate (PEDOT/PSS), polyaniline, polyacetylene or polyphenylenevinylene.
